(19) United States
(12) Patent Application Publication
(10) Pub. No.: US 2025/0142242 A1
(43) Pub. Date: May 1, 2025

(54) SIGHT BLOCKING DEVICE FOR USE WITH MICROPHONE HEADSETS

(71) Applicant: Gary C. Hoyle, Cumming, GA (US)

(72) Inventor: Gary C. Hoyle, Cumming, GA (US)

(21) Appl. No.: 18/928,510

(22) Filed: Oct. 28, 2024

Related U.S. Application Data
(60) Provisional application No. 63/593,789, filed on Oct. 27, 2023.

(51) Int. Cl. H04R 1/08

(52) U.S. Cl. CPC H04R 1/086

(57) ABSTRACT

A sight blocking device, comprising a shield configured to block or cover a mouth of an individual wearing a microphone headset; and a mechanism for coupling a microphone of the microphone headset to the shield, wherein the shield is configured to rotate away from and toward the mouth of the individual.

### CROSS-REFERENCE TO RELATED APPLICATIONS

This patent application claims the benefit of U.S. Provisional Patent Application Ser. No. 63/593,789 filed on Oct. 27, 2023 and entitled “Sight Blocking Shield For Use With Microphone Headsets,” the disclosure of which is hereby incorporated by reference herein in its entirety and made part of the present U.S. utility patent application for all purposes.

### BACKGROUND

The disclosed technology relates in general to audio devices and apparatuses and more specifically to accessories for use with audio devices such as microphone headsets used in athletic, sporting, and gaming environments.

Headsets are frequently worn by coaches and other individuals involved in athletics, sports, gaming, and other activities. Such headsets typically include a microphone connected to the wearable headset portion by way of a flexible microphone stem. However, because the microphone covers only a small portion of the individuals' mouth, unwanted parties can read the individuals' lips, compromising secrecy in the words spoken by the individuals. Accordingly, there is an ongoing need for an attachable or integrated device that completely covers the mouth of the individual wearing the headset so that calls or signs made by the individual cannot be seen by others (i.e. “sight blocking”). Additionally, the disclosed devices can advantageously rotate away from and toward the individual's mouth without having to bend the stem of the microphone.

### SUMMARY

The following provides a summary of certain example implementations of the disclosed technology. This summary is not an extensive overview and is not intended to identify key or critical aspects or elements of the disclosed technology or to delineate its scope. However, it is to be understood that the use of indefinite articles in the language used to describe and claim the disclosed technology is not intended in any way to limit the described technology. Rather the use of “a” or “an” should be interpreted to mean “at least one” or “one or more”.

One implementation of the disclosed technology provides a sight blocking device, comprising a shield configured to block or cover a mouth of an individual wearing a microphone headset; and a mechanism for coupling a microphone of the microphone headset to the shield, wherein the shield is configured to rotate away from and toward the mouth of the individual.

In various implementations, the shield comprises a base that extends from an interior surface of the shield, wherein the base includes a cut-out region that defines a prong, wherein the prong includes a first stop and a second stop. In some implementations, the mechanism for coupling the microphone to the shield comprises a clip having a first clip member; and a second clip member, wherein the first clip member and the second clip member are configured to define an opening that receives a stem of the microphone headset. The first clip member may include a flange configured to engage the base, wherein the flange comprises a notch formed in a cavity, wherein the shield rotates away from the mouth of the individual until the notch engages the second stop, and wherein the shield rotates toward the mouth of the individual until the notch engages the first stop. In some implementations, the mechanism for coupling the microphone the shield comprises a clip having a first clip member having a first channel formed thereon; a second clip member having a second channel formed thereon, wherein the first clip member and the second clip member are configured to define an opening that receives a stem of the microphone headset; and a threaded screw having a first end and a second end that extends between the first channel and the second channel, wherein the first end is coupled to a fastener and the second end is coupled to a pin. The first clip member may include a flange configured to engage the base, wherein the flange comprises a notch formed in a cavity, wherein the shield rotates away from the mouth of the individual until the notch engages the second stop, and wherein the shield rotates toward the mouth of the individual until the notch engages the first stop. In various implementations, rotation of the fastener in a first direction drives the fastener along the treaded screw towards the second end to lock the clip, and wherein rotation of the fastener in a second direction drives the fastener along the threaded screw towards the first end to unlock the clip. In some implementations, the mechanism for coupling the microphone to the shield comprises a flange extending from the microphone, and wherein the flange is configured to engage the base and integrate the microphone with the shield. The flange may comprise a notch formed in a cavity, wherein the shield rotates away from the mouth of the individual until the notch engages the second stop, and wherein the shield rotates toward the mouth of the individual until the notch engages the first stop. In various implementations, the shield comprises an exterior surface configured to receive logos, advertisement, or combinations thereof. In various implementations, the shield is solid, opaque, screen-like, or combinations thereof, and wherein the shield is substantially rectangular, oval, round, trapezoidal, or elongated hexagonal.

Another implementation of the disclosed technology provides a sight blocking device, comprising a shield configured to block or cover a mouth of an individual wearing a microphone headset; and a clip, wherein the clip is configured to receive a stem of the microphone headset, and wherein the shield is rotatable about the clip to move the shield away from and toward the mouth of the individual.

In some implementations, the shield is rotatable about the clip to move the shield away from and toward the mouth of the individual without bending the stem of the microphone headset. In various implementations, the shield comprises a base that extends from an interior surface of the shield, wherein the base includes a cut-out region that defines a prong, wherein the prong includes a first stop and a second stop. In some implementations, the clip comprises a first clip member; and a second clip member, wherein the first clip member and the second clip member are configured to define an opening that receives the stem of the microphone headset. The first clip member may include a flange configured to engage the base, wherein the flange comprises a notch formed in a cavity, wherein the shield rotates away from the mouth of the individual until the notch engages the second stop, and wherein the shield rotates toward the mouth of the individual until the notch engages the first stop. In some implementations, the first clip member further comprises a first channel, and wherein the second clip member further comprises a second channel. In some implementations, the sight blocking device further comprises a threaded screw having a first end and a second end that extends between the first channel and the second channel, wherein the first end is coupled to a fastener and the second end is coupled to a pin, wherein rotation of the fastener in a first direction drives the fastener along the treaded screw towards the second end to lock the clip, and wherein rotation of the fastener in a second direction drives the fastener along the threaded screw towards the first end to unlock the clip. The shield may comprises an exterior surface configured to receive logos, advertisement, or combinations thereof, and wherein the shield is solid, opaque, screen-like, or combinations thereof.

Still another implementation of the disclosed technology provides a sight blocking device for use with a microphone headset, comprising a shield configured to block or cover a mouth of an individual wearing a microphone headset; and a flange configured to integrate a microphone of the microphone headset into the shield.

In some implementations, the shield comprises a base that extends from an interior surface of the shield, wherein the base includes a cut-out region that defines a prong, wherein the prong includes a first stop and a second stop. In some implementations, the flange extends from the microphone and is configured to engage the base, and wherein the flange comprises a notch formed in a cavity, wherein the shield rotates away from the mouth of the individual until the notch engages the second stop, and wherein the shield rotates toward the mouth of the individual until the notch engages the first stop. In various implementations, the shield is rotatable about the flange to move the shield away from and toward the mouth of the individual. The shield may include an exterior surface configured to receive logos, advertisement, or combinations thereof. The shield may be is solid, opaque, screen-like, or combinations thereof, and the shield may be substantially rectangular, oval, round, trapezoidal, or elongated hexagonal.

It should be appreciated that all combinations of the foregoing concepts and additional concepts discussed in greater detail below (provided such concepts are not mutually inconsistent) are contemplated as being part of the technology disclosed herein and may be implemented to achieve the benefits as described herein. Additional features and aspects of the disclosed system, devices, and methods will become apparent to those of ordinary skill in the art upon reading and understanding the following detailed description of the example implementations. As will be appreciated by the skilled artisan, further implementations are possible without departing from the scope and spirit of what is disclosed herein. Accordingly, the drawings and associated descriptions are to be regarded as illustrative and not restrictive in nature.

### BRIEF DESCRIPTION OF THE DRAWINGS

The accompanying drawings, which are incorporated into and form a part of the specification, schematically illustrate one or more example implementations of the disclosed technology and, together with the general description given above and detailed description given below, serve to explain the principles of the disclosed subject matter, and wherein:

FIG. 1 is a right rear perspective view of an example implementation of the disclosed device in a fully assembled configuration;

FIG. 2 is a right side view of the device of FIG. 1;

FIG. 3 is a front view of the device of FIG. 1;

FIG. 4 is a right rear perspective view of the device of FIG. 1 shown in an exploded configuration, wherein the disclosed device comprises a shield, a clip, a pin, a threaded screw, and a fastener;

FIG. 5 is a right rear perspective view of the shield of FIG. 4;

FIG. 6 is a front perspective view of the clip of FIG. 4;

FIG. 7 is a bottom perspective view of the clip of FIG. 4;

FIG. 8 is a right side view of the clip of FIG. 4;

FIG. 9 is a right rear perspective view of the pin, the treaded screw, and the fastener of FIG. 4 is an exploded configuration;

FIGS. 10A-10B depict the device of FIG. 1 coupled to an exemplary microphone of a microphone headset, wherein FIG. 10A depicts the disclosed device in a sight-blocking position, and wherein FIG. 10B depicts the disclosed device rotated into an exposed position;

FIG. 11 depicts the device of FIG. 1 covering the mouth of a user wearing the exemplary microphone headset;

FIG. 12 is a left side view of FIG. 11 showing the disclosed device coupled to the exemplary microphone headset;

FIG. 13 is a rear perspective view of another example implementation of the disclosed device in a fully assembled configuration;

FIG. 14 is a top-down, rear perspective view of the device of FIG. 13;

FIG. 15 is a front perspective view of the device of FIG. 13;

FIG. 16 depicts the device of FIG. 13 coupled to an exemplary microphone of a microphone headset in a sight-blocking position;

FIGS. 17A-17B depict the device of FIG. 13 coupled to the microphone headset, wherein FIG. 17A depicts the disclosed device rotated towards the mouth of a user wearing the exemplary microphone headset, and wherein FIG. 17B depicts the disclosed device rotated away from the mouth of the user wearing the microphone headset;

FIG. 18 is a right rear perspective view of still another example implementation of the disclosed device in a fully assembled configuration;

FIG. 19 is a front perspective view of the device of FIG. 18;

FIG. 20 is a right rear perspective view of the device of FIG. 18 in an exploded configuration, wherein the disclosed device comprises a shield and a microphone having a flange; and

FIG. 21 is a front perspective view of the microphone of FIG. 20.

### DETAILED DESCRIPTION

Example implementations are now described with reference to the Figures. Reference numerals are used throughout the detailed description to refer to the various elements and structures. Although the following detailed description contains many specifics for the purposes of illustration, a person of ordinary skill in the art will appreciate that many variations and alterations to the following details are within the scope of the disclosed technology. Accordingly, the following implementations are set forth without any loss of generality to, and without imposing limitations upon, the claimed subject matter.

The examples discussed herein are examples only and are provided to assist in the explanation of the apparatuses, devices, systems, and methods described herein. None of the features or components shown in the drawings or discussed below should be taken as required for any specific implementation of any of these the apparatuses, devices, systems or methods unless specifically designated as such. For ease of reading and clarity, certain components, modules, or methods may be described solely in connection with a specific Figure. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Example implementations of the disclosed systems, devices, and methods provide a device that completely covers the mouth of an individual wearing a microphone headset so that calls or signs made by the individual cannot be seen by others; hence the phrase “sight blocking”, which refers to the sight of someone looking at the individual wearing the disclosed device. When using the disclosed device, the possibility of lip reading the words spoken by the individual wearing the microphone headset is greatly reduced or completely eliminated because the mouth of the individual is completely covered by the device. The disclosed device is either: (i) an attachable accessory for use with the microphone headset; or (ii) an integrated component of the microphone or microphone headset. The disclosed devices can advantageously rotate away from and toward the individual's mouth without having to bend the stem of the microphone. The disclosed devices may also be adapted or configured for receiving logos, advertisements, or other printed information or images.

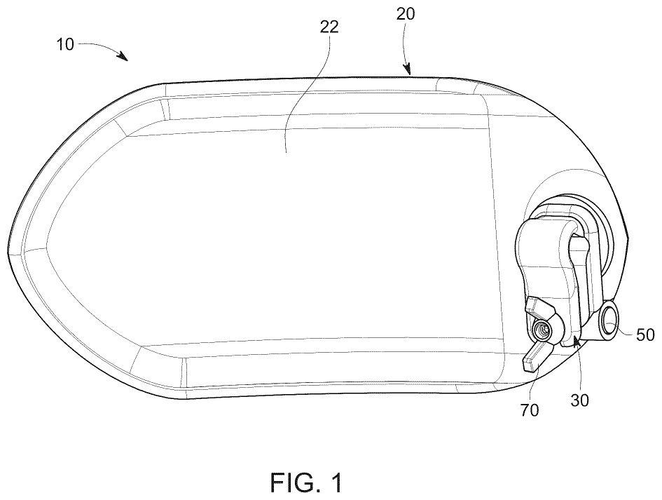

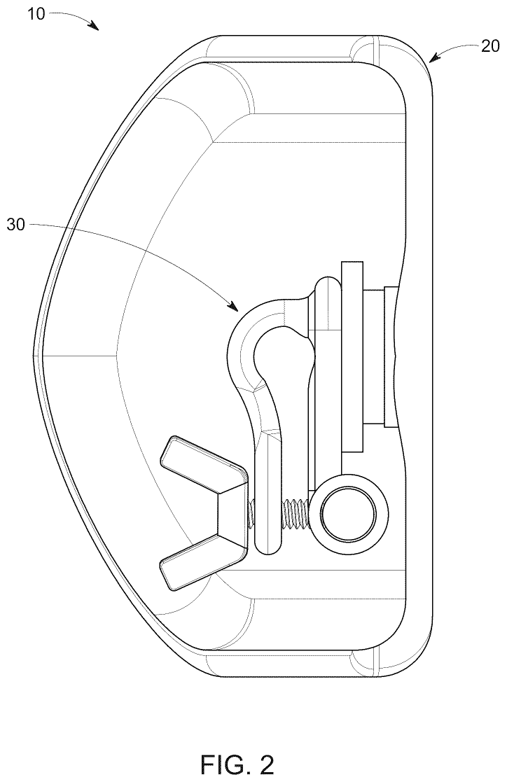

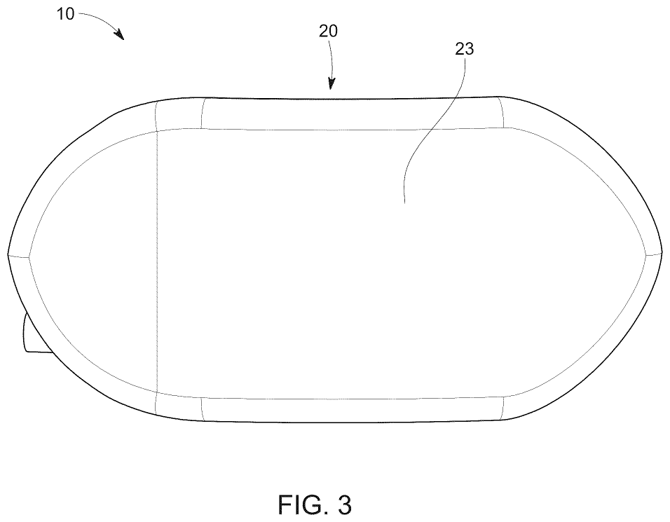

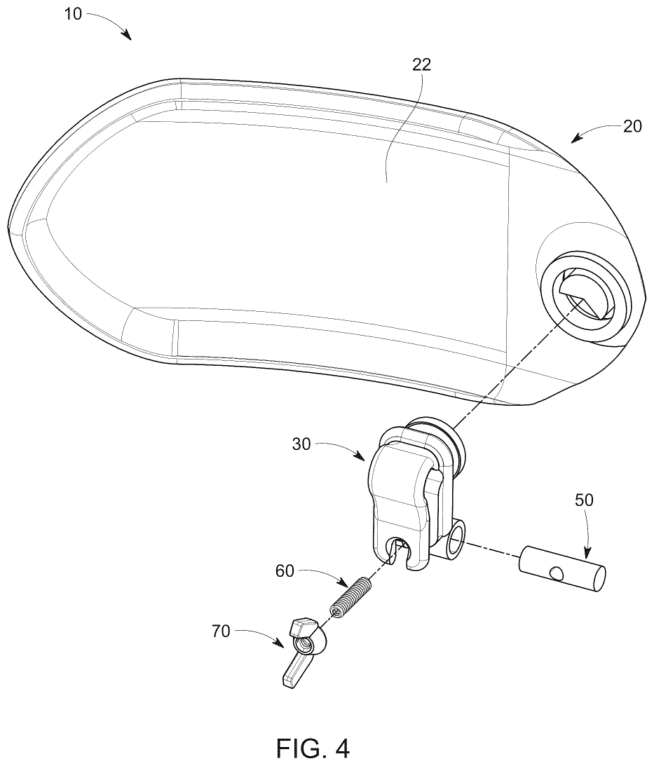

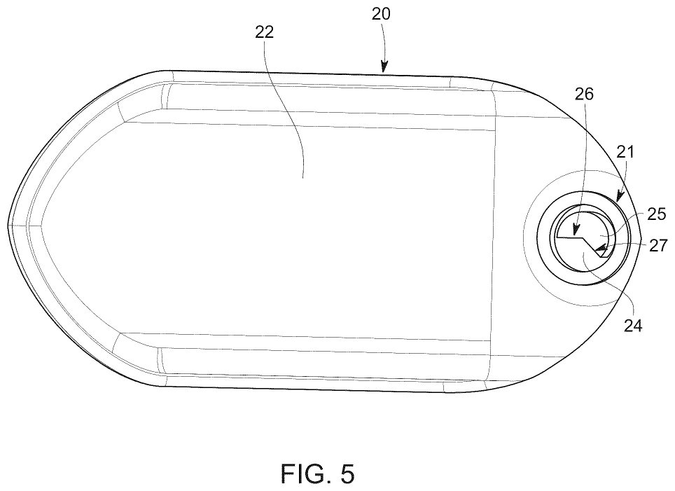

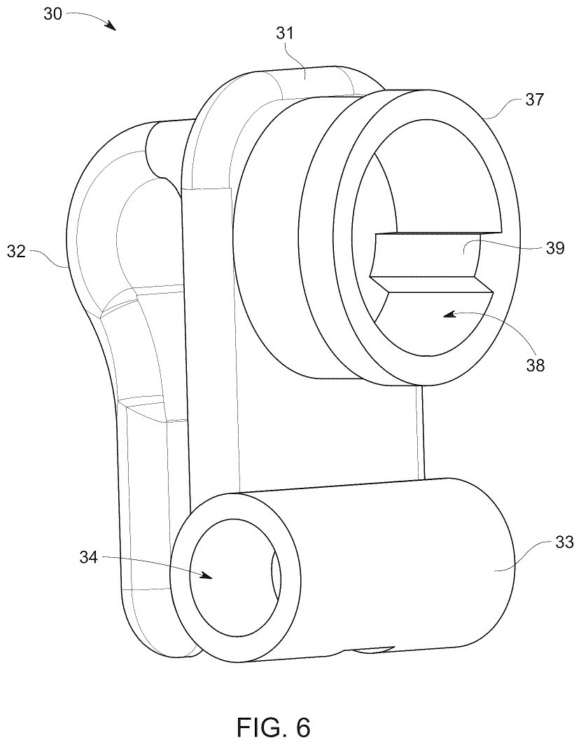

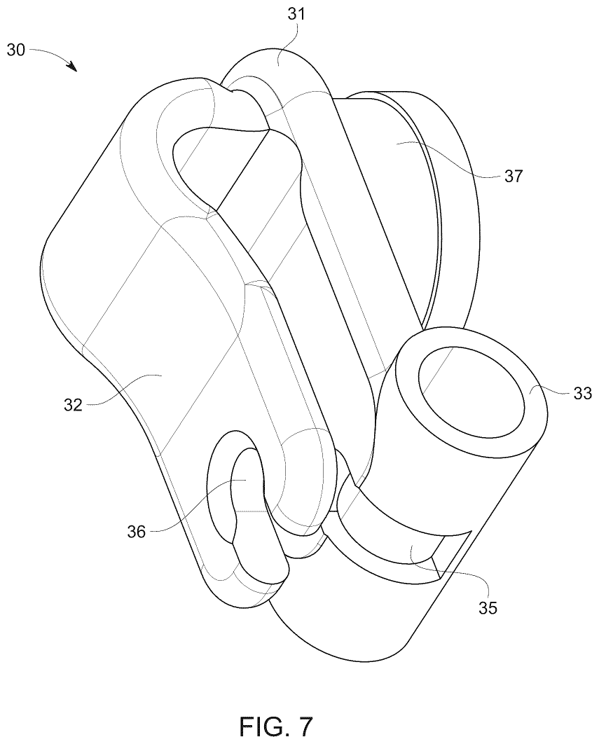

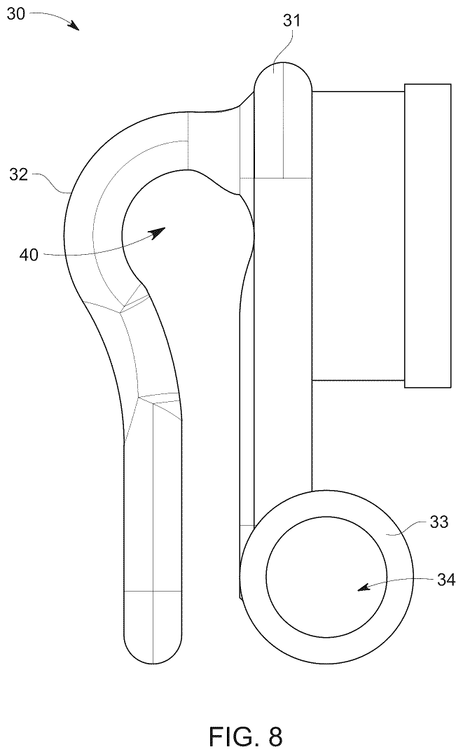

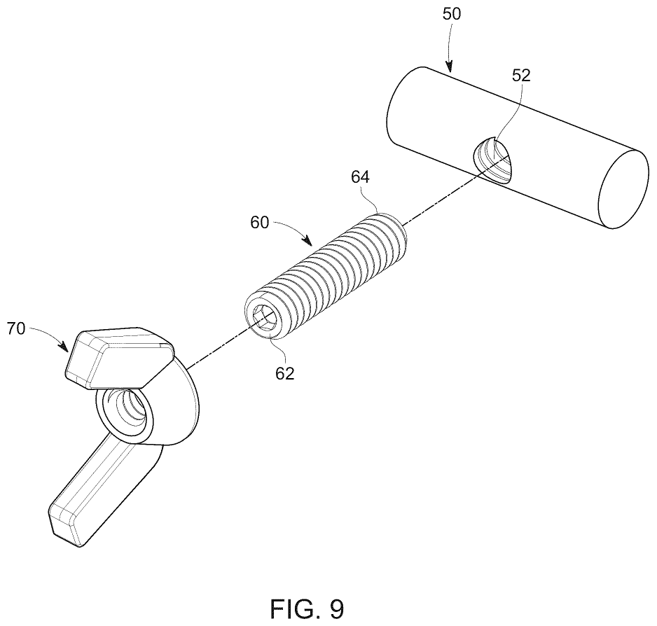

FIG. 1 is a right rear perspective view of an example implementation of the disclosed device in a fully assembled configuration; FIG. 2 is a right side view of the device of FIG. 1; FIG. 3 is a front view of the device of FIG. 1; FIG. 4 is a right rear perspective view of the device of FIG. 1 shown in an exploded configuration, wherein the disclosed device comprises a shield, a clip, a pin, a threaded screw, and a fastener; FIG. 5 is a right rear perspective view of the shield of FIG. 4; FIG. 6 is a front perspective view of the clip of FIG. 4; FIG. 7 is a bottom perspective view of the clip of FIG. 4; FIG. 8 is a right side view of the clip of FIG. 4; and FIG. 9 is a right rear perspective view of the pin, the treaded screw, and the fastener of FIG. 4 is an exploded configuration.

With specific reference to FIGS. 1-9, sight blocking device 10 includes shield 20 and clip 30, wherein clip 30 attachably and detachably couples to shield 20. Shield 20 comprises base 21 that extends from interior surface 22; and exterior surface 23. Base 21 includes cut-out region 24 that defines prong 25 formed therein. Prong 25 includes first stop 26 and second stop 27.

Still referring to FIGS. 1-9, clip 30 is configured to attach and detach to base 21. Clip 30 includes first clip member 31 and second clip member 32, wherein first clip member 31 and second clip member 32 define opening 40. First clip member 31 includes housing 33 having slot 34 that is configured to receive pin 50. First clip member 31 further includes first channel 35 formed thereon that is substantially perpendicular to slot 34 in housing 33. Second clip member 32 includes second channel 36 formed thereon that is substantially collinear with first channel 35. Flange 37 extends from first clip member 31, wherein flange 37 includes cavity 38 having notch 39 formed therein. Base 21 of shield 20 is configured to receive flange 37 such that prong 25 mates with cavity 38.

Still referring to FIGS. 1-9, device 10 further includes pin 50, threaded screw 60, and wing nut or similar fastener 70. Pin 50, threaded screw 60, and wing nut 70 cooperate with clip 30 to lock and unlock clip 30. Pin 50 includes aperture 52 that aligns with first and second channels 35, 36 when pin 50 is inserted into slot 34, and pin 50 is free to rotate or pivot within slot 34. Threaded screw 60 includes first end 62 and second end 64, wherein first end 62 is configured to engage wing nut or similar fastener 70, and wherein second end 64 is configured to engage aperture 52 of pin 50. Threaded screw 60 can pivot in and out of first and second channels 35, 36 depending if clip 30 is locked or unlocked.

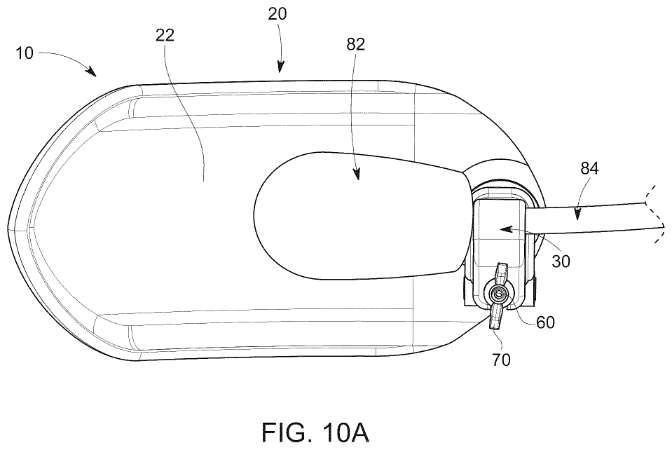

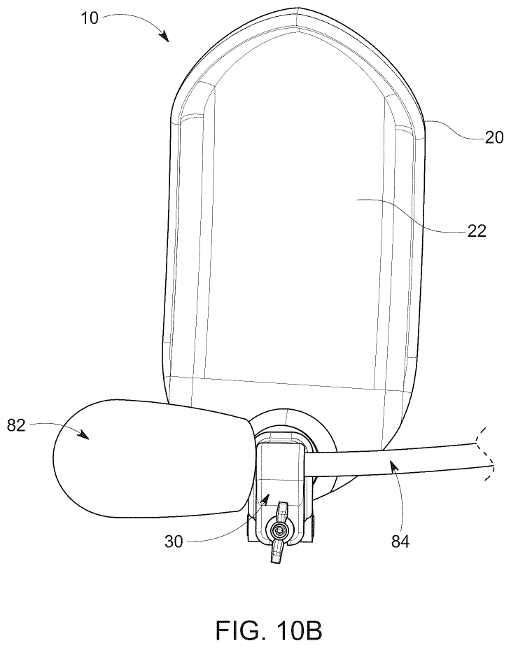

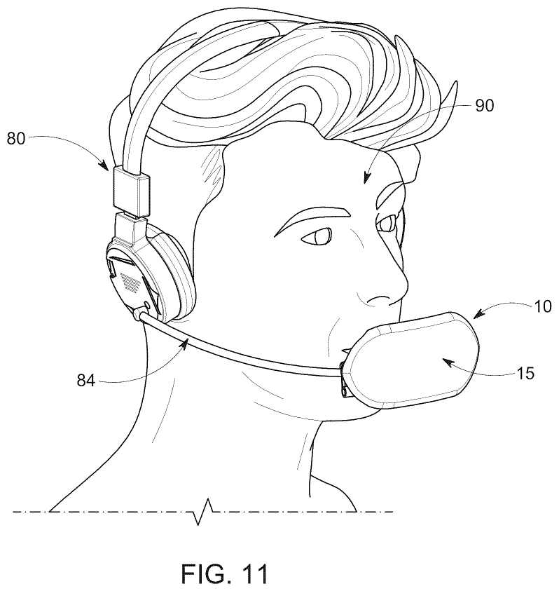

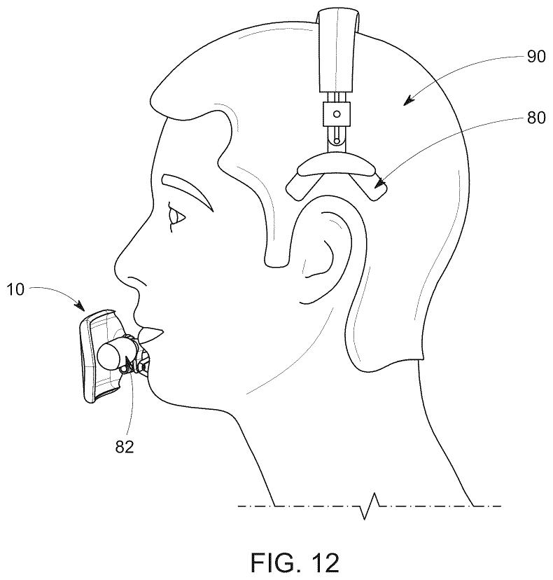

FIGS. 10A-10B depict the device of FIG. 1 coupled to an exemplary microphone of a microphone headset, wherein FIG. 10A depicts the disclosed device in a sight-blocking position, and wherein FIG. 10B depicts the disclosed device rotated into an exposed position; FIG. 11 depicts the device of FIG. 1 covering the mouth of a user wearing the exemplary microphone headset; and FIG. 12 is a left side view of FIG. 11 showing the disclosed device coupled to the exemplary microphone headset.

Now referring to FIGS. 1-12, device 10 is attachable to and detachable from headset 80 worn by user 90. Headset 80 includes microphone 82 that is coupled to headset 80 by way of flexible stem 84. Opening 40 receives flexible stem 84 to attachably couple device 10 to headset 80 (see FIGS. 10A-10B). Shield 20 is rotatable about clip 30 between a sight-blocking position (FIG. 10A) and an exposed position (FIG. 10B). In the sight-blocking position, shield 20 is rotated towards the mouth of user 90 until notch 39 in flange 37 engages first stop 26 of prong 25 in base 21. In the exposed position, shield 20 is rotated away from the mouth of user 90 until notch 39 engages second stop 27 of prong 25. Exterior surface 23 may be adapted or configured for receiving logos, advertisements, or other printed information or images 15 (see FIG. 11).

Still referring to FIGS. 1-12, in one exemplary method or process for attaching device 10 to headset 80, the following steps are performed: (i) rotate wing nut 70 in a second direction to drive wing nut 70 towards first end 62 of threaded screw 60; (ii) pivot threaded screw 60 away from first and second channels 35, 36 until threaded screw 60 is substantially parallel with first clip member 31; (iii) insert flexible stem 84 having microphone 82 into opening 40; (iv) pivot threaded screw 60 towards first and second channels 35, 36 until threaded screw 60 is contained within first and second channels 35, 36 and is substantially perpendicular to first clip member 31; and (v) rotate wing nut 70 in a first direction to drive wing nut 70 towards second end 64 of threaded screw 60, thereby locking clip 31 onto headset 80. Once device 10 is attached to headset 80, shield 20 can be rotated about clip 30 to move shield 20 away from and toward the mouth of the user 90 without needing to bend stem 84 (see FIGS. 10A-10B and 11-12).

Still referring to FIGS. 1-12, in one exemplary method or process for detaching device 10 from headset 80, the following steps are performed: (i) rotate wing nut 70 in a second direction to drive wing nut 70 towards first end 62 of threaded screw 60; (ii) pivot threaded screw 60 away from first and second channels 35, 36 until threaded screw 60 is substantially parallel with first clip member 31; (iii) pull clip 30 away from flexible stem 84 until detached; (iv) pivot threaded screw 60 towards first and second channels 35, 36 until threaded screw 60 is contained within first and second channels 35, 36 and is substantially perpendicular to first clip member 31; and (v) rotate wing nut 70 in a first direction to drive wing nut 70 towards second end 64 of threaded screw 60.

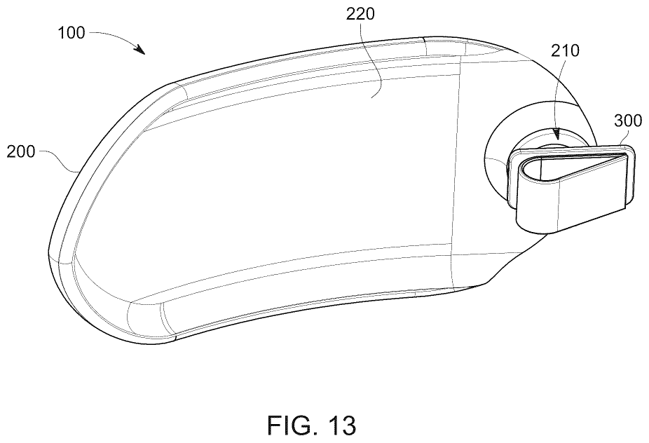

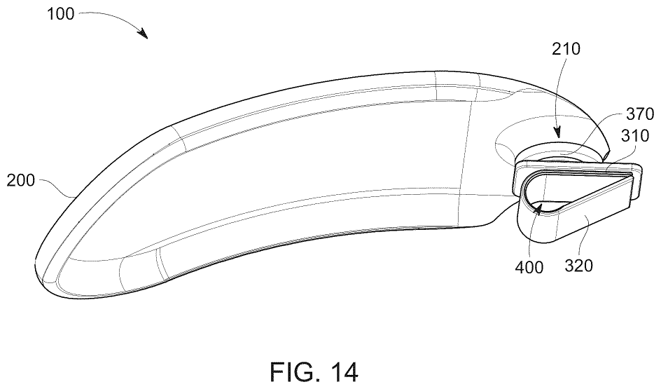

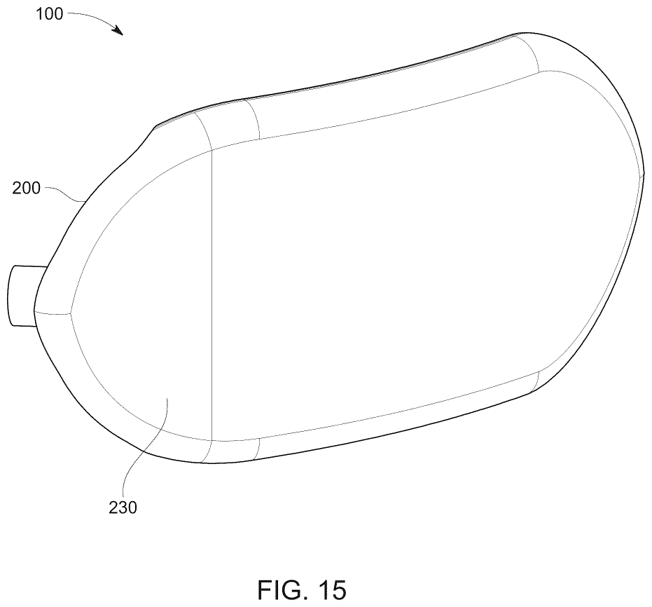

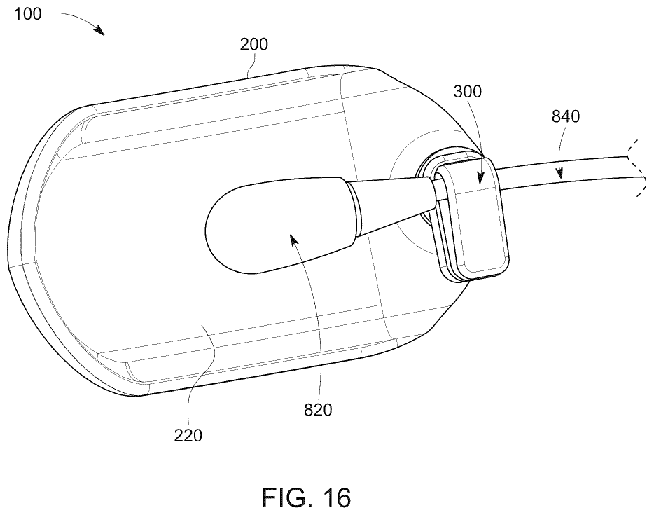

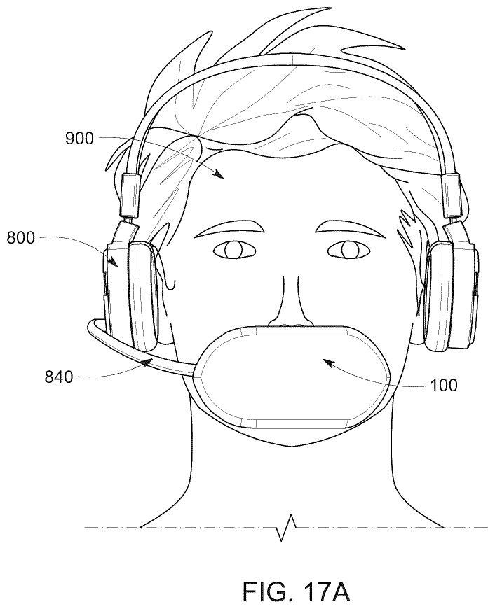

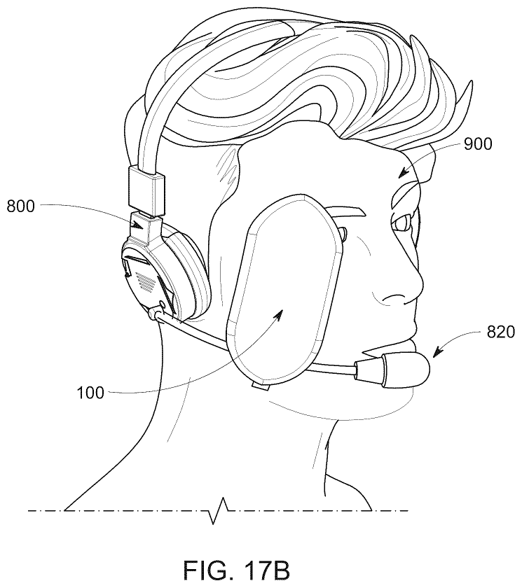

FIG. 13 is a rear perspective view of another example implementation of the disclosed device in a fully assembled configuration; FIG. 14 is a top-down, rear perspective view of the device of FIG. 13; FIG. 15 is a front perspective view of the device of FIG. 13; FIG. 16 depicts the device of FIG. 13 coupled to an exemplary microphone of a microphone headset in a sight-blocking position; and FIGS. 17A-17B depict the device of FIG. 13 coupled to the microphone headset, wherein FIG. 17A depicts the disclosed device rotated towards the mouth of a user wearing the exemplary microphone headset, and wherein FIG. 17B depicts the disclosed device rotated away from the mouth of the user wearing the microphone headset.

With reference to FIGS. 13-16 and 17A-17B, sight blocking device 100 includes shield 200 and clip 300, wherein clip 300 attachably and detachably couples to shield 200. Shield 200 comprises base 210 that extends from interior surface 220; and exterior surface 230. Clip 300 is configured to attach and detach to base 210. Clip 300 includes first clip member 31 and second clip member 32, wherein first clip member 31 and second clip member 32 define opening 40 that receives flexible stem 840 having microphone 820, to attachably couple device 100 to headset 800 (see FIGS. 16 and 17A-17B). Flange 370 extends from first clip member 310. Base 210 of shield 200 is configured to receive flange 370. Shield 200 is rotatable about clip 300 between a sight-blocking position (FIG. 17A) and an exposed position (FIG. 17B).

Sight blocking device 100 functions similarly as that of slight blocking device 10, the difference being that sight blocking device 100 does not include a pin, threaded screw, or fastener assembly. It is to be appreciated that flange 370 includes similar components as that of flange 37 of sight-blocking device 10, and that base 210 includes similar components as that of base 21 of sight-blocking device 10.

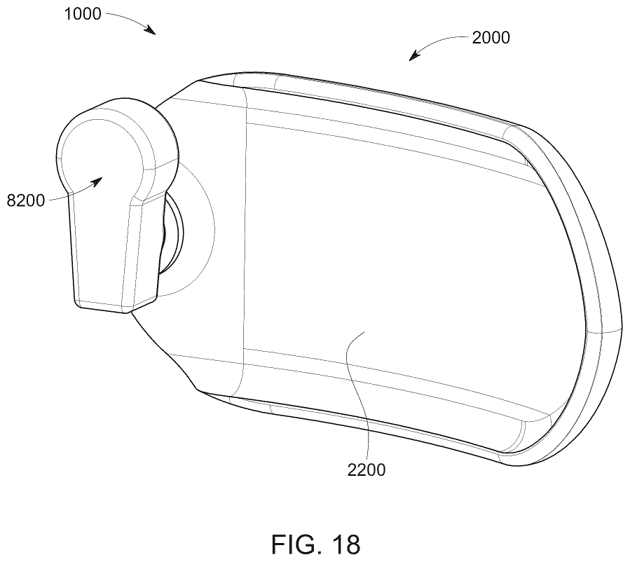

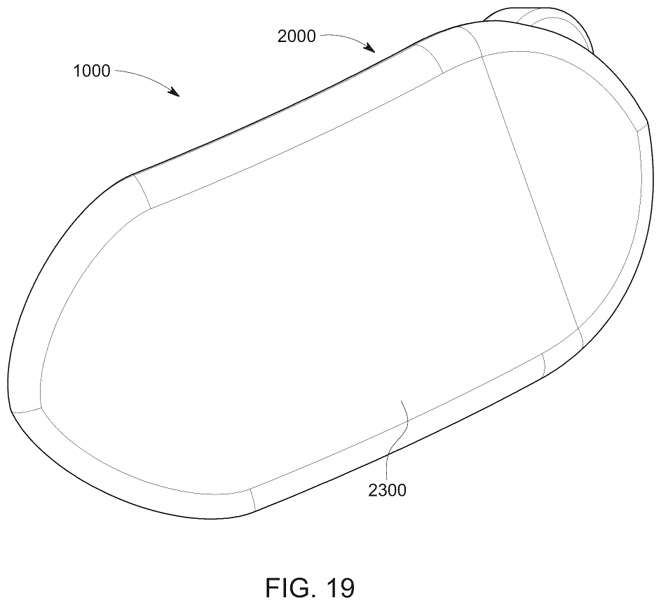

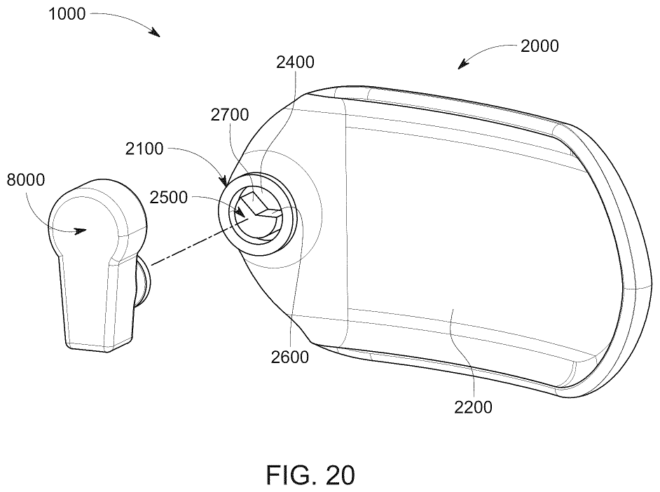

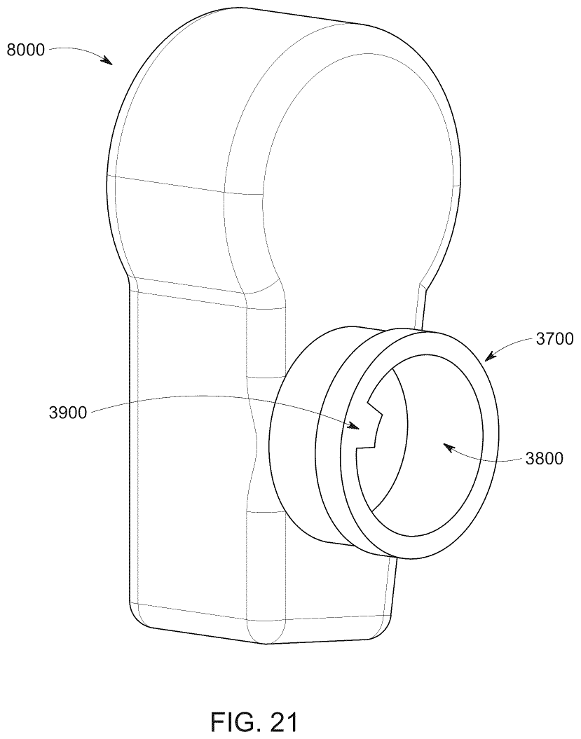

FIG. 18 is a right rear perspective view of still another example implementation of the disclosed device in a fully assembled configuration; FIG. 19 is a front perspective view of the device of FIG. 18; FIG. 20 is a right rear perspective view of the device of FIG. 18 in an exploded configuration, wherein the disclosed device comprises a shield and a microphone having a flange; and FIG. 21 is a front perspective view of the microphone of FIG. 20.

With reference to FIGS. 18-20, sight blocking device 1000 includes microphone 8200 integrated into shield 2000. Shield 2000 includes base 2100 that extends from interior surface 2200. Shield 2000 further comprises exterior surface 2300. Base 2100 includes cut-out region 2400 that defines prong 2500 formed therein. Prong 2500 includes first stop 2600 and second stop 2700.

Still referring to FIGS. 18-20, microphone 8200 has flange 3700 extending therefrom, wherein flange 3700 includes cavity 3800 having notch 3900 formed therein. Base 2100 of shield 2000 is configured to receive flange 3700 such that prong 2500 mates with cavity 3800. Shield 2000 is rotatable about clip 3000 between a sight-blocking position and an exposed position. In the sight-blocking position, shield 2000 is rotated towards the mouth of a user until notch 3900 in flange 3700 engages first stop 2600 of prong 2500 in base 2100. In the exposed position, shield 2000 is rotated away from the mouth of the user until notch 3900 engages second stop 2700 of prong 2500.

It is to be appreciated that microphone 8200 can be coupled to a wearable headset by way of a flexible stem, as described and illustrated in previous disclosed implementations, or microphone 8200 can be independent such that the flexible stem of the headset attaches at various locations on shield 2000. Microphone 8200 may also be integrally formed with shield 2000.

The bases formed on the disclosed sight blocking devices can be positioned on either the left side or right side of the interior surface of the shields or may be present on both sides (left and right) of the shields. Such positioning of the bases allows the disclosed clips and flanges to attach accordingly to the bases on either the left side or right side or on both sides (left and right).

The shields used with the disclosed sight blocking devices may be generally rectangular, oval, round, trapezoidal, elongated hexagonal, or any other suitable geometry in shape. The shields used with the disclosed sight blocking devices may be formed from a solid material, an opaque material, or a screen-like material that allows sufficient air flow around and through the shield. The shields used with the disclosed sight blocking devices may be flat or may include a slight inward curvature that corresponds to the contours of the face and head of the user for optimal coverage.

The exterior surface of the shields used with the disclosed sight blocking devices may be adapted or configured for receiving logos, advertisements, or other printed information or images.

All literature and similar material cited in this application, including, but not limited to, patents, patent applications, articles, books, treatises, and web pages, regardless of the format of such literature and similar materials, are expressly incorporated by reference in their entirety. Should one or more of the incorporated references and similar materials differs from or contradicts this application, including but not limited to defined terms, term usage, described techniques, or the like, this application controls.

As previously stated and as used herein, the singular forms “a,” “an,” and “the,” refer to both the singular as well as plural, unless the context clearly indicates otherwise. The term “comprising” as used herein is synonymous with “including,” “containing,” or “characterized by,” and is inclusive or open-ended and does not exclude additional, unrecited elements or method steps. Although many methods and materials similar or equivalent to those described herein can be used, particular suitable methods and materials are described herein. Unless context indicates otherwise, the recitations of numerical ranges by endpoints include all numbers subsumed within that range. Furthermore, references to “one implementation” are not intended to be interpreted as excluding the existence of additional implementations that also incorporate the recited features. Moreover, unless explicitly stated to the contrary, implementations “comprising” or “having” an element or a plurality of elements having a particular property may include additional elements whether or not they have that property.

The terms “substantially” and “about”, if or when used throughout this specification describe and account for small fluctuations, such as due to variations in processing. For example, these terms can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%, and/or 0%.

Underlined and/or italicized headings and subheadings are used for convenience only, do not limit the disclosed subject matter, and are not referred to in connection with the interpretation of the description of the disclosed subject matter. All structural and functional equivalents to the elements of the various implementations described throughout this disclosure that are known or later come to be known to those of ordinary skill in the art are expressly incorporated herein by reference and intended to be encompassed by the disclosed subject matter. Moreover, nothing disclosed herein is intended to be dedicated to the public regardless of whether such disclosure is explicitly recited in the above description.

There may be many alternate ways to implement the disclosed technology. Various functions and elements described herein may be partitioned differently from those shown without departing from the scope of the disclosed technology. Generic principles defined herein may be applied to other implementations. Different numbers of a given module or unit may be employed, a different type or types of a given module or unit may be employed, a given module or unit may be added, or a given module or unit may be omitted.

Regarding this disclosure, the term “a plurality of” refers to two or more than two. Unless otherwise clearly defined, orientation or positional relations indicated by terms such as “upper” and “lower” are based on the orientation or positional relations as shown in the FIGS., only for facilitating description of the disclosed technology and simplifying the description, rather than indicating or implying that the referred devices or elements must be in a particular orientation or constructed or operated in the particular orientation, and therefore they should not be construed as limiting the disclosed technology. The terms “connected”, “mounted”, “fixed”, etc. should be understood in a broad sense. For example, “connected” may be a fixed connection, a detachable connection, or an integral connection; a direct connection, or an indirect connection through an intermediate medium. For an ordinary skilled in the art, the specific meaning of the above terms in the disclosed technology may be understood according to specific circumstances.

It should be appreciated that all combinations of the foregoing concepts and additional concepts discussed in greater detail herein (provided such concepts are not mutually inconsistent) are contemplated as being part of the disclosed technology. In particular, all combinations of claimed subject matter appearing at the end of this disclosure are contemplated as being part of the technology disclosed herein. While the disclosed technology has been illustrated by the description of example implementations, and while the example implementations have been described in certain detail, there is no intention to restrict or in any way limit the scope of the appended claims to such detail. Additional advantages and modifications will readily appear to those skilled in the art. Therefore, the disclosed technology in its broader aspects is not limited to any of the specific details, representative devices and methods, and/or illustrative examples shown and described. Accordingly, departures may be made from such details without departing from the spirit or scope of the general inventive concept.

What is claimed:

1. A sight blocking device, comprising:
(a) a shield configured to block or cover a mouth of an individual wearing a microphone headset; and
(b) a mechanism for coupling a microphone of the microphone headset to the shield, wherein the shield is configured to rotate away from and toward the mouth of the individual.

2. The sight blocking device of claim 1, wherein the shield comprises a base that extends from an interior surface of the shield, wherein the base includes a cut-out region that defines a prong, wherein the prong includes a first stop and a second stop.

3. The sight blocking device of claim 2, wherein the mechanism for coupling the microphone to the shield comprises a clip having:
(a) a first clip member; and
(b) a second clip member, wherein the first clip member and the second clip member are configured to define an opening that receives a stem of the microphone headset.

4. The sight blocking device of claim 3, wherein the first clip member includes a flange that is configured to engage the base, wherein the flange comprises a notch formed in a cavity, wherein the shield rotates away from the mouth of the individual until the notch engages the second stop, and wherein the shield rotates toward the mouth of the individual until the notch engages the first stop.

5. The sight blocking device of claim 2, wherein the mechanism for coupling the microphone to the shield comprises a clip having:
(a) a first clip member having a first channel formed thereon;
(b) a second clip member having a second channel formed thereon, wherein the first clip member and the second clip member are configured to define an opening that receives a stem of the microphone headset; and
(c) a threaded screw having a first end and a second end that extends between the first channel and the second channel, wherein the first end is coupled to a fastener and the second end is coupled to a pin.

6. The sight blocking device of claim 5, wherein the first clip member includes a flange that is configured to engage the base, wherein the flange comprises a notch formed in a cavity, wherein the shield rotates away from the mouth of the individual until the notch engages the second stop, and wherein the shield rotates toward the mouth of the individual until the notch engages the first stop.

7. The sight blocking device of claim 5, wherein rotation of the fastener in a first direction drives the fastener along the treaded screw towards the second end to lock the clip, and wherein rotation of the fastener in a second direction drives the fastener along the threaded screw towards the first end to unlock the clip.

8. The sight blocking device of claim 2, wherein the mechanism for coupling the microphone to the shield comprises a flange extending from the microphone, and wherein the flange is configured to engage the base and integrate the microphone into the shield.

9. The sight blocking device of claim 8, wherein the flange comprises a notch formed in a cavity, wherein the shield rotates away from the mouth of the individual until the notch engages the second stop, and wherein the shield rotates toward the mouth of the individual until the notch engages the first stop.

10. The sight blocking device of claim 1, wherein the shield comprises an exterior surface that is configured to receive logos, advertisement, or combinations thereof.

11. The sight blocking device of claim 1, wherein the shield is solid, opaque, screen-like, or combinations thereof, and wherein the shield is substantially rectangular, oval, round, trapezoidal, or elongated hexagonal.

12. A sight blocking device, comprising:
(a) a shield configured to block or cover a mouth of an individual wearing a microphone headset; and
(b) a clip, wherein the clip is configured to receive a stem of the microphone headset, and wherein the shield is rotatable about the clip to move the shield away from and toward the mouth of the individual.

13. The sight blocking device of claim 12, wherein the shield is rotatable about the clip to move the shield away from and toward the mouth of the individual without bending the stem of the microphone headset.

14. The sight blocking device of claim 12, wherein the shield comprises a base that extends from an interior surface of the shield, wherein the base includes a cut-out region that defines a prong, wherein the prong includes a first stop and a second stop.

15. The sight blocking device of claim 14, wherein the clip comprises:
(a) a first clip member; and
(b) a second clip member, wherein the first clip member and the second clip member are configured to define an opening that receives the stem of the microphone headset.

16. The sight blocking device of claim 15, wherein the first clip member includes a flange that is configured to engage the base, wherein the flange comprises a notch formed in a cavity, wherein the shield rotates away from the mouth of the individual until the notch engages the second stop, and wherein the shield rotates toward the mouth of the individual until the notch engages the first stop.

17. The sight blocking device of claim 15, wherein the first clip member further comprises a first channel, and wherein the second clip member further comprises a second channel.

18. The sight blocking device of claim 17, further comprising a threaded screw having a first end and a second end that extends between the first channel and the second channel, wherein the first end is coupled to a fastener and the second end is coupled to a pin, wherein rotation of the fastener in a first direction drives the fastener along the treaded screw towards the second end to lock the clip, and wherein rotation of the fastener in a second direction drives the fastener along the threaded screw towards the first end to unlock the clip.

19. The sight blocking device of claim 12, wherein the shield comprises an exterior surface configured to receive logos, advertisement, or combinations thereof, and wherein the shield is solid, opaque, screen-like, or combinations thereof.

20. A sight blocking device for use with a microphone headset, comprising:
(a) a shield configured to block or cover a mouth of an individual wearing a microphone headset; and
(b) a flange configured to integrate a microphone of the microphone headset into the shield.

21. The sight blocking device of claim 20, wherein the shield comprises a base that extends from an interior surface of the shield, wherein the base includes a cut-out region that defines a prong, wherein the prong includes a first stop and a second stop.

22. The sight blocking device of claim 21, wherein the flange extends from the microphone and is configured to engage the base, and wherein the flange comprises a notch formed in a cavity, wherein the shield rotates away from the mouth of the individual until the notch engages the second stop, and wherein the shield rotates toward the mouth of the individual until the notch engages the first stop.

23. The sight blocking device of claim 20, wherein the shield is rotatable about the flange to move the shield away from and toward the mouth of the individual.

24. The sight blocking device of claim 20, wherein the shield includes an exterior surface that is configured to receive logos, advertisement, or combinations thereof.

25. The sight blocking device of claim 20, wherein the shield is solid, opaque, screen-like, or combinations thereof, and wherein the shield is substantially rectangular, oval, round, trapezoidal, or elongated hexagonal.
